(19) United States
(12) Patent Application Publication
(10) Pub. No.: US 2015/0052501 A1
(43) Pub. Date: Feb. 19, 2015

(54) CONTINUOUS DEPLOYMENT OF CODE CHANGES

(71) Applicants: Inbar Shani, Kibutz Beit Kama (IL); Ilan Shufer, Tel Aviv (IL); Amichai Nitsan, Rehovot (IL)

(72) Inventors: Inbar Shani, Kibutz Beit Kama (IL); Ilan Shufer, Tel Aviv (IL); Amichai Nitsan, Rehovot (IL)

(21) Appl. No.: 14/374,841

(22) PCT Filed: Jan. 31, 2012
(86) PCT No.: PCT/US2012/023252

§ 371 Date: Jul. 25, 2014

(51) Int. Cl. G06F 9/445; G06F 11/36

(52) U.S. Cl. CPC G06F 8/60; G06F 11/3688
USPC 717/124

(57) ABSTRACT

A processor implemented method to deploy a code change in a software application. The code change is assigned to a deployment pipeline based on a filtering rule. The code change is deployed after the code change passes a set of test criteria associated with the deployment pipeline.

### BACKGROUND

Software development life cycles use continuous integration (CI) and continuous deployment (CD) to reduce the time code changes spend in a production line. Continuous integration automates the process of receiving code changes from a specific source configuration management (SCM) tool, constructing deliverable assemblies with the code changes, and testing the assemblies. Continuous deployment automates the deployment of the code changes into an environment by executing application programming interface, functional, and/or performance tests on the assembly with the code changes.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a network environment according to an example;

FIGS. 2-3 illustrate block diagrams of systems to automatically deploy a code change in a software application according to examples;

FIG. 4 illustrates a block diagram of a computer readable medium useable with a system, according to an example;

FIG. 5 illustrates a schematic diagram of deployment pipelines according to an example; and

FIGS. 6-7 illustrate flow charts of methods to automatically deploy a code change in a software application according to examples.

### DETAILED DESCRIPTION

In the following detailed description, reference is made, to the accompanying drawings which form a part hereof, and in which is illustrated by way of specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

Continuous integration (CI) and continuous deployment (CD) automate the construction testing, and deployment of code assemblies with a code change. The automation begins after a code change is committed to a source configuration management (SCM) tool. When the code change is committed to the SCM tool, the code change is assigned to a particular continuous deployment pipeline (CD pipeline or deployment pipeline) manually by a developer and/or release manager. The code change moves through the deployment pipeline as the code change is tested as part of a code assembly. The amount of testing is determined by the deployment pipeline. For example, a normal pipeline may be thoroughly tested, but an urgent or high priority pipeline may only include a few tests in order to get the code into production quicker. The use of continuous deployment with manual assignment to a continuous deployment pipeline introduces risks, such as deployment of low quality and/or high impact changes that may jeopardize the system if deployed without sufficient testing.

In examples, a method and system to automatically filter and deploy a code change in a software application is provided herein. The method assigns the code change to a deployment pipeline based on a filtering rule. The code change is deployed after the code change passes a set of test criteria associated with the deployment pipeline.

The phrase “code change” refers to a change in the source code for any software application. The phrase code change may also refer to a code change that is part of a code assembly constructed as part of a continuous integration process.

The phrase “deployment pipeline” refers to a set of actions executed serially and/or in parallel on a queue of code changes. For example, the deployment pipeline may include building the code, executing unit tests, deploying code, running automated tests, staging the code, running end-to-end tests and deploying the code to production. The code changes queue may include code changes that match a defined set of criteria for example the queue may have criteria to add a code change to a specific deployment pipeline if the code change is of low risk and high priority.

The phrase “filtering rule” refers to a predefined rule used to sort the code changes based on at least one criterion.

The phrase “business criteria” refers to business factors that are used with the filtering rules to assign code changes to a deployment pipeline. The business criteria corresponds to data associated with the code changes, such as author of a code change, number of lines of code in the code change, and/or number of files changed.

The phrase “test criteria” refers to a defined set of factors that the code change is required to pass prior to deployment.

The phrase “set of tests” refers to the tests run a simulated environment using the code changes to test functionality and/or identify deficiencies of the code change.

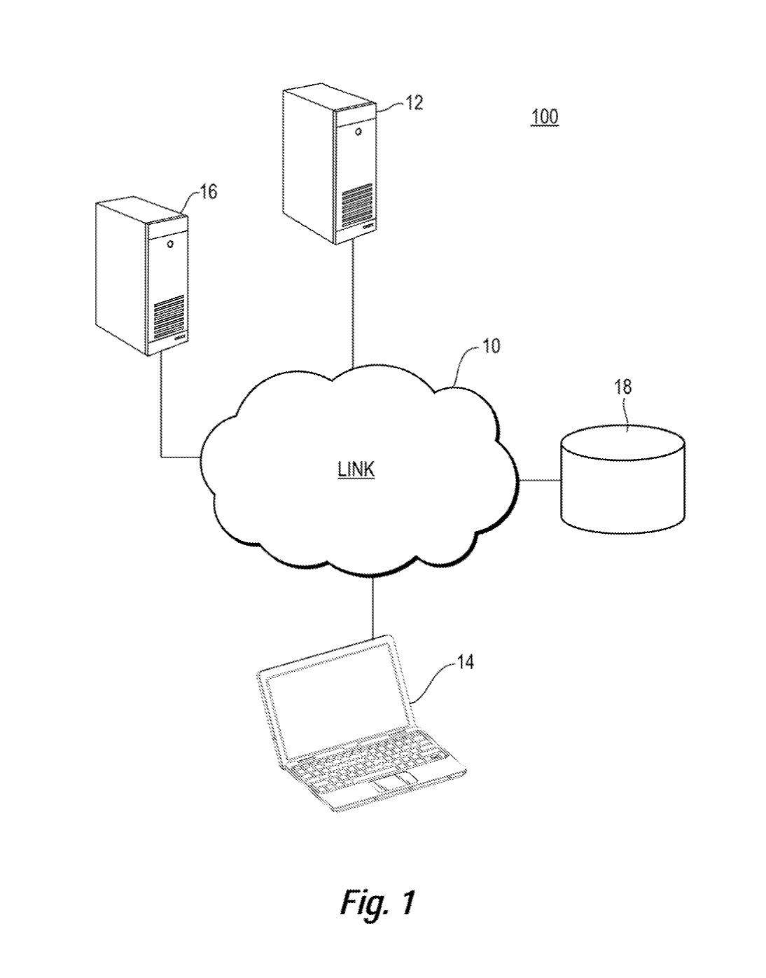

FIG. 1 illustrates a network environment 100 according to an example. The network environment 100 includes a link 10 that connects a deployment device 12, a client device 14, a test device 16, and a data store 18. The deployment device 12 represents generally any computing device or combination of computing devices that receive a code change from at least one client device 14.

The client device 14 represents a computing device and/or a combination of computing devices configured to interact with the deployment device 12 via the link 10. The interaction may include sending and/or transmitting data on behalf of a user, such as the code change. The client device 14 may be, for example, a personal computing device with includes software that enables the user to create and/or edit code for a software application.

The test device 16 represents a computing device that runs a set of tests on the code changes in the deployment pipeline. The test device 16 may run the test in an application under test environment that simulates use of the code changes with the software application. The set of tests may be stored in the data store 18. The data store 18 represents generally any memory configured to store data that can be accessed by the test device 16 in the performance of its function. The test device 16 functionalities may be accomplished via the link 10 that connects the test device 16 to the deployment device 12 and the data store 18.

The link 10 represents generally one or more of a cable, wireless, fiber optic, or remote connections via a telecommunication link, an infrared link, a radio frequency link, or any other connectors or systems that provide electronic communication. The link 10 may include, at least in part, an intranet, the Internet, or a combination of both. The link 10 may also include intermediate proxies, routers, switches, load balancers, and the like.

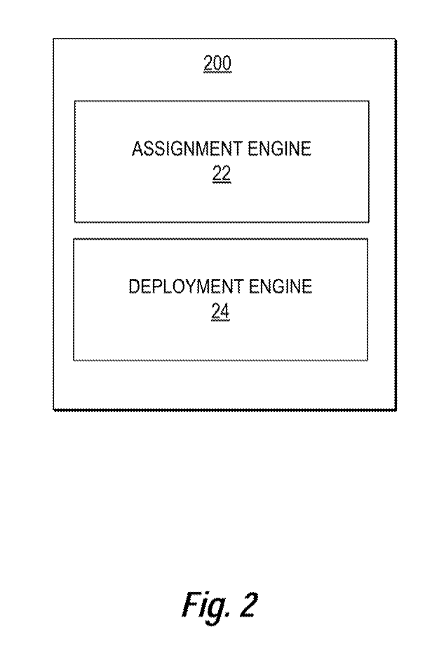

FIG. 2 illustrates a block diagram of a system 100 to automatically deploy a code change in a software application according to an example. Referring to FIG. 2, the system 200 includes an assignment engine 22 and a deployment engine 24. The assignment engine 22 represents generally a combination of hardware and/or programming that assigns the code change to a deployment pipeline based on a filtering rule. The deployment engine 24 represents generally a combination of hardware and/or programming that deploys the code change after the code change passes a set of test criteria associated with the deployment pipeline. The deployment engine 24 maintains one and/or a plurality of deployment pipelines.

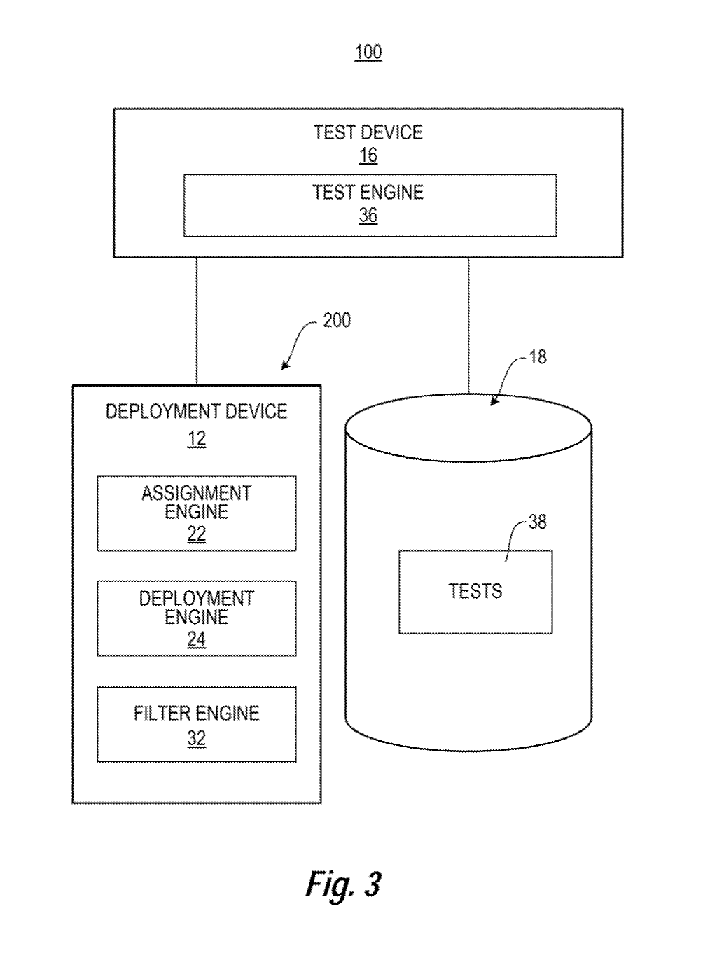

FIG. 3 illustrates a block diagram of the system 200 in a network environment 100 according to a further example. The system 200 illustrated in FIG. 3 includes the deployment device 12, the test device 16 and the data store 18. The deployment device 12 is illustrated as including the assignment engine 22 and the deployment engine 24. The deployment device 12 is connected to the test device 16, which tests the code change that is in the deployment pipeline.

The deployment device 12 further includes a filter engine 32. The filter engine 32 represents generally a combination of hardware and/or programming that sorts the code change based on a filtering rule. For example, the filter engine 32 sorts the code change using a predefined set of business criteria associated with the code change.

The test device 16 includes a test engine 36. The test engine 36 represents generally a combination of hardware and/or programming that runs a set of tests on the code change in an application under test environment. The test device 16 is connected to the data store 18. The data store 18 is, for example, a database that stores the set of tests 38. The assignment engine 22, the monitor engine 24, and the test engine 36 may work together to automate the deployment of the code change.

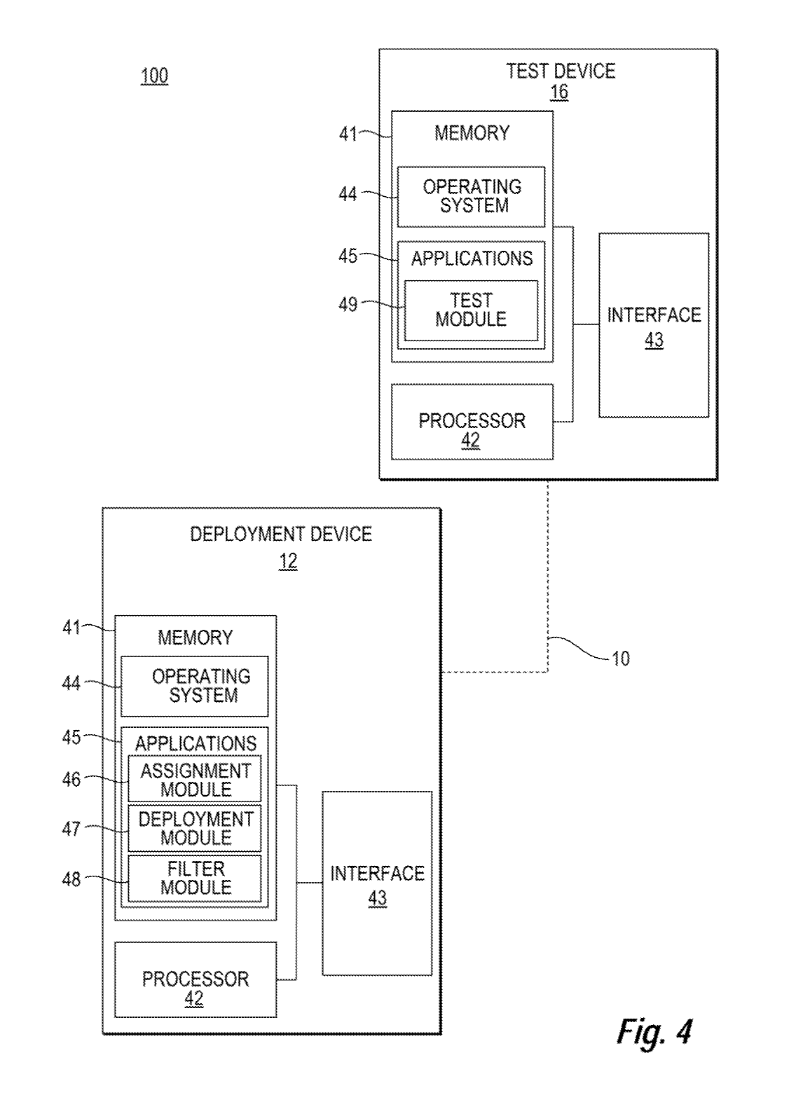

FIG. 4 illustrates a block diagram of a computer readable medium useable with the system 200 of FIG. 2 according to an example. In FIG. 4, the deployment device 12 is illustrated to include a memory 41, a processor 42, and an interface 43. The processor 42 represents generally any processor configured to execute program instructions stored in memory 41 to perform various specified functions. The interface 43 represents generally any interface enabling the deployment device 12 to communicate with the client device 14 and/or the test device 16 via the link 10.

The memory 41 is illustrated to include an operating system 44 and applications 45. The operating system 44 represents a collection of programs that when executed by the processor 42 serve as a platform on which applications 45 may run. Examples of operating systems 43 include various versions of Microsoft's Windows® and Linux®. Applications 45 represent program instructions that when executed by the processor 42 function as an application that automatically deploys code changes in a software application. For example, FIG. 4 illustrates an assignment module 46, a deployment module 47, and a filter module 48 as executable program instructions stored in memory 41 of the deployment device 12.

Referring back to FIGS. 2-3, the assignment engine 22, the deployment engine 24, and the filter engine 32 are described as combinations of hardware and/or programming. As illustrated in FIG. 4, the hardware portions may include the processor 42. The programming portions may include the operating system 44, applications 45, and/or combinations thereof. For example, the assignment module 46 represents program instructions that when executed by a processor 42 cause the implementation of the of the assignment engine 22 of FIGS. 2-3. The deployment module 47 represents program instructions that when executed by a processor 42 cause the implementation of the of the deployment engine 24 of FIGS. 2-3. The filter module 48 represents program instructions that when executed by a processor 42 cause the implementation of the of the filter engine 32 of FIG. 3.

Similarly, the test device 16 is illustrated to include a memory 41, a processor 42, and an interface 43. The processor 42 represents generally any processor to execute program instructions stored in the memory 41 to perform various specified functions. The interface 43 represents generally any interface enabling test device 16 to communicate with the deployment device 12 and/or client device 14. The interface 43 represents generally any interface enabling the test device 16 to communicate with the deployment device 41 via the test device 16.

The memory 41 is illustrated to include an operating system 44 and applications 45. The operating system 44 represents a collection of programs that when executed by the processor 42 serve as a platform on which applications 45 may run. Examples of operating systems include various versions of Microsoft's Windows® and Linux®. Applications 45 represent program instructions that when executed by the processor 42 causes a set of tests 38 to be run using the code changes as discussed above with respect to FIGS. 2-3. For example, FIG. 4 illustrates a test module 49 as executable program instructions stored in memory 41 of the test device 16.

Referring back to FIG. 3, the test engine 36 is described as combinations of hardware and/or programming. As illustrated in FIG. 4, the hardware portions may include the processor 42. The programming portions may include the operating system 44, applications 45, and/or combinations thereof. For example, the test module 49 represents program instructions that when executed by a processor 42 cause the implementation of the of the test engine 36 of FIG. 3.

The programming of the assignment module 46, deployment module 47, filter module 48, and test module 49 may be processor executable instructions stored on a memory 41 that includes a tangible memory media and the hardware may include a processor 42 to execute the instructions. The memory 41 may store program instructions that when executed by the processor 42 cause the processor 42 to perform the program instructions. The memory 41 may be integrated in the same device as the processor 42 or it may be separate but accessible to that device and processor 42.

In some examples, the program instructions may be part of an installation package that can be executed by the processor 42 to perform a method using the system 200. The memory 41 may be a portable medium such as a CD, DVD, or flash drive or a memory maintained by a server from which the installation package can be downloaded and installed. In some examples, the program instructions may be part of an application or applications already installed on the server. In further examples, the memory 41 may include integrated memory such as a hard drive.

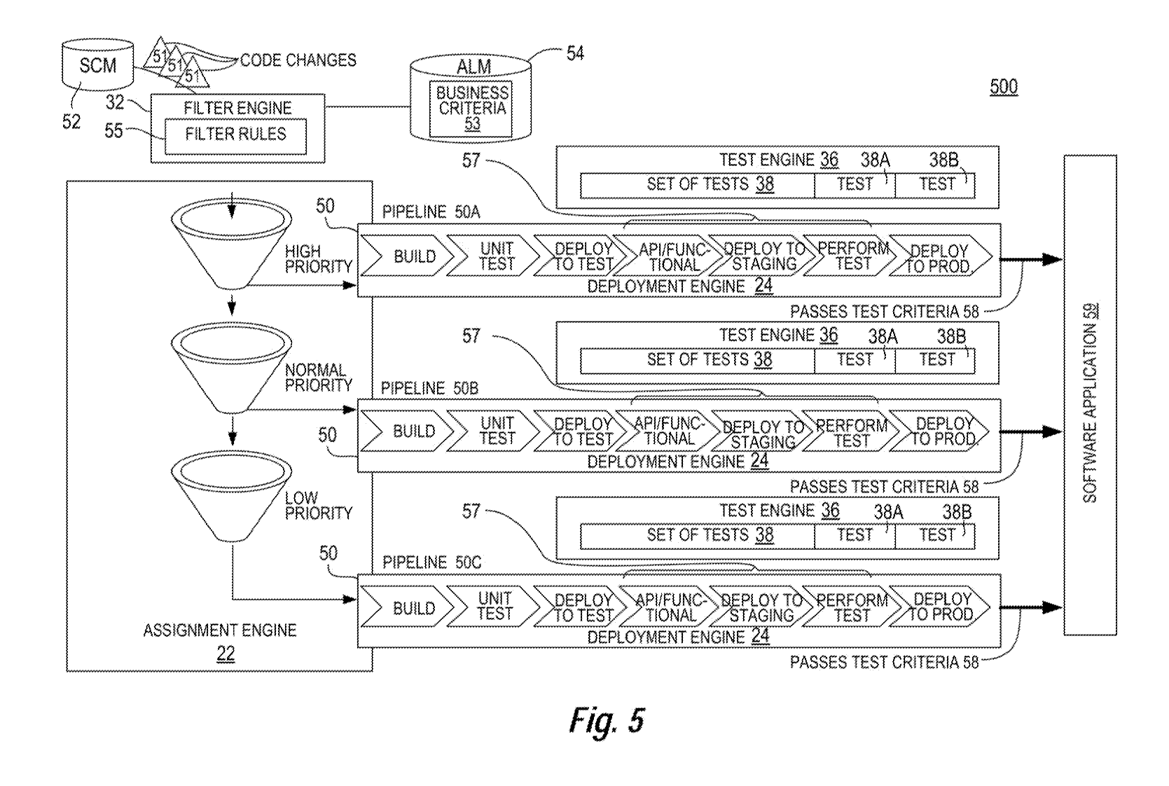

FIG. 5 illustrates a schematic diagram 500 of deployment pipelines 50 according to an example. The filter engine 32 receives a code change 51 from a source configuration management (SCM) tool 52 and business criteria 53 from an application lifecycle management (ALM) tool 54. The filter rules 55 use the predetermined set of business criteria 53 and associated data from the code change 51 to sort the code change 51. The assignment engine 22 assigns the code change 51 to a deployment pipeline 50, such as deployment pipelines 50A, 50B, 50C. The filter rules 55 may alternatively be referred to as entry criteria for each pipeline. For example, deployment pipeline 50A may be a high priority pipeline 50A for code changes 51 that are determined by the filter rules 55 to be tested and deployed quickly without thorough testing. Similarly, deployment pipeline 50B may be a normal priority pipeline and deployment pipeline 50C may be a low priority pipeline. The normal priority pipeline 50B is for code changes that are determined by the filter rules to be tested and deployed in a typical or routine manner with thorough testing. The low priority pipeline 50C is for code changes 51 that are determined by the filter rules 55 to be tested and deployed thoroughly but less frequently than the code changes 51 in the high priority pipeline 50A and the normal priority pipeline 50B.

After the code changes 51 are filtered by the filter engine 32, the code changes 51 remain in the respective deployment pipeline 50 until the code, change 51 passes the test criteria 58. For example, test criteria may be passed each time the code change passes a set of tests 38. Passing test criteria or a set of tests 38 may occur after the deployment engine 24 sends the code change 51 to the test engine 36 to run the set of tests 38 associated with the test pipeline, as illustrated in line 57. FIG. 5 illustrates the set of tests 38 as tests 38A-38B. For example, tests 38A may be application program interface (API)/functional tests; and tests 38B may be performance tests, such as an application under test environment. After the code change 51 is determined to pass the set of tests 38 the deployment engine 24 determines when the code change 51 passes the exit criteria 58, which includes the set of tests 38 and/or any additional criteria associated with the deployment pipeline 50, and deploys the code change or releases the code change 51 to the software application 59.

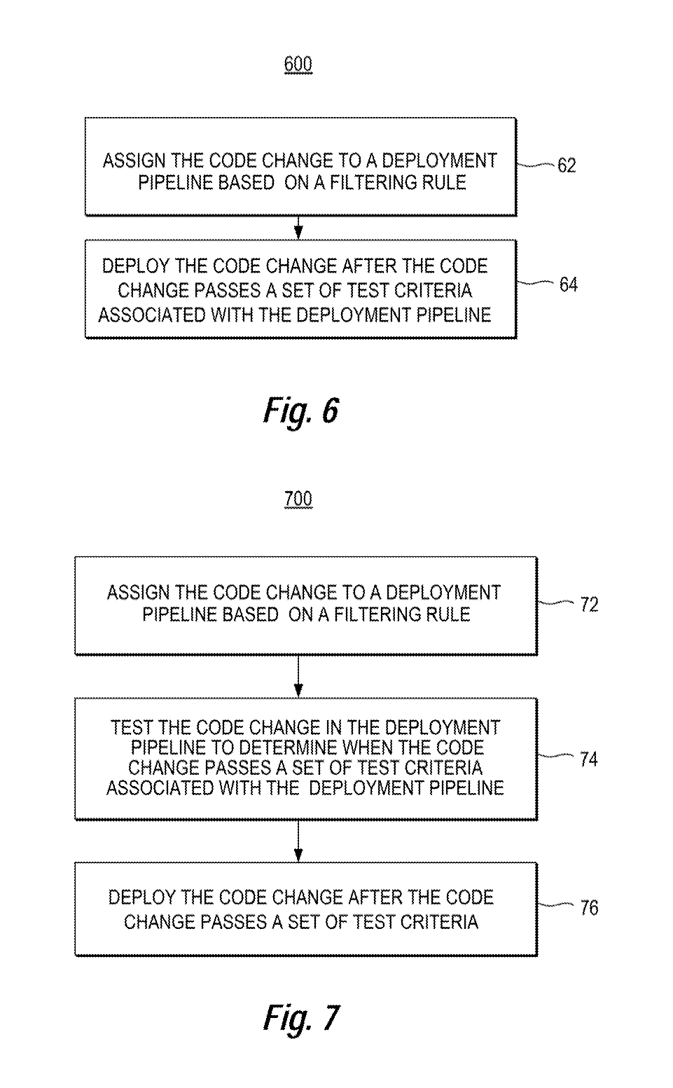

FIG. 6 illustrates a flow diagram 600 of a method, such as a processor implemented method, to automatically deploy a code change in a software application according to an example. In block 62, the code change, is assigned to a deployment pipeline based on a filtering rule. The filtering rule is defined using, for example, a predefined set of business criteria associated with the code change.

The code change is deployed in block 64 after the code change passes a set of test criteria associated with the deployment pipeline. The code change that is in the deployment pipeline may be tested to determine when the code change passes the set of test criteria. For example, the test criteria includes a set of tests run in the application under test environment using the code change and a determination of when the code change passes the set of test criteria based on results of the set at tests. The code change is moved through the deployment pipeline based on the results of the set of tests. The movement through the deployment pipeline may occur by moving the code change back and forth between the deployment engine and the test engine between each test and/or at the end of a series of test depending on the implementation.

FIG. 7 illustrates a flow diagram 700 of a method, such as a processor implemented method, to automatically deploy a code change in a software application according to a further example. In block 72, the code change is assigned to a deployment pipeline according to a filtering rule. The deployment pipeline may include a plurality of deployment pipelines. The filtering rule may be defined using at least one predefined set of business criteria associated with the code change. For example, application of the filtering rule includes evaluation of the code change using data associated with the code change.

The code change in the deployment pipeline is tested in block 74 to determine when the code change passes a set of test criteria associated with the deployment pipeline. Block 76 deploys the code change after the code charge passes the set of test criteria.

FIGS. 1-7 aid in illustrating the architecture, functionality, and operation according to examples. The examples illustrate various physical and logical components. The various components illustrated are defined at least in part as programs, programming, or program instructions. Each such component, portion thereof, or various combinations thereof may represent in whole or in part a module, segment, or portion of code that comprises one or more executable instructions to implement any specified logical function(s). Each component various combinations thereof may represent a circuit or a number of interconnected circuits to implement the specified logical function(s).

Examples can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIGS. 6-7 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

The present disclosure has been described using non-limiting detailed descriptions of examples thereof and is not intended to limit the scope of the present disclosure. It should be understood that features and/or operations described with respect to one example may be used with other examples and that not all examples of the present disclosure, have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A processor implemented method to deploy a code change in a software application, the method comprising:
assigning the code change to a deployment pipeline based on a filtering rule; and
deploying the code change after the code change passes a set of test criteria associated with the deployment pipeline.

2. The method of claim 1, further comprising defining the filtering rule using a predefined set of business criteria associated with the code change.

3. The method of claim 1, further comprising testing the code change in the deployment pipeline to determine when the code change passes the set of test criteria.

4. The method of claim 3, wherein testing the code change further comprises:
running a set of tests in an application under test environment using the code change, and
determining when the code change passes the set of test criteria based on results of the set of tests.

5. The method of claim 1, further comprising moving the code change through the deployment pipeline based on results of the set of tests.

6. A computer readable medium having stored thereon instructions that, when executed by a processor, cause the processor to perform a method to deploy a code change in a software application, the method comprising:
assigning the code change to a deployment pipeline according to a filtering rule;
testing the code change in the deployment pipeline to determine when the code change passes a set of test criteria associated with the deployment pipeline; and
deploying the code change after the code change passes the set of test criteria.

7. The computer readable medium of claim 6, further comprising evaluating the code change using data associated with the code change.

8. The computer readable medium of claim 6, further comprising defining the filtering rule using at least one predefined set of business criteria associated with the code change.

9. The computer readable medium of claim 6, further comprising maintaining a plurality of deployment pipelines.

10. A system to deploy a code change in a software application, the system comprising:
an assignment engine to assign the code change to a deployment pipeline based on a filtering rule; and
a deployment engine to deploy the code change after the code change passes a set of test criteria associated with the deployment pipeline.

11. The system of claim 10, further comprising a filter engine to sort the code change based on the filtering rule.

12. The system of claim 11, wherein the filter engine sorts the code change using a predefined set of business criteria associated with the code change.

13. The system of claim 10, wherein the deployment engine maintains a plurality of deployment pipelines.

14. The system of claim 10, further comprising a test device that includes a test engine to run a set of tests on the code change in an application under test environment.

15. The system claim 13, further comprising a data store to store the set of tests.
